(19) United States
(12) Patent Application Publication
(10) Pub. No.: US 2008/0264226 A1
(43) Pub. Date: Oct. 30, 2008

(54) PUNCH UNIT

(75) Inventor: Ken Iguchi, Sunto-gun (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: TOSHIBA TEC KABUSHIKI KAISHA, Tokyo (JP)

(21) Appl. No.: 11/739,156

(22) Filed: Apr. 24, 2007

(51) Int. Cl. B26D 5/08

(52) U.S. Cl. 83/588

(57) ABSTRACT

For automatic return control of the punch blades, the punch blades are returned to the home position after one failure by making a retry in an inverse direction or by storing the driving phase when the last driving ended and by rotating the punch blade in a direction inverse to the direction in the phase at the end of the driving.

### BACKGROUND OF THE INVENTION

1. Field of the Invention

The present invention relates to a punch unit that perforates a sheet of paper discharged from an image forming apparatus or the like.

2. Description of the Related Art

In a case where perforation processing is chosen as post-processing after image formation, when a sheet of paper is supplied to the perforation position of a paper perforation device (hereinafter, referred to also as the punch unit), the perforation processing is performed by moving down or up the punch blades from the home position (hereinafter, occasionally abbreviated to HP) at which the punch blades are held back. In order to secure a torque necessary to perforate a sheet of paper, a DC motor is often used to drive the punch unit. For example, perforation processing is performed once for a half rotation by controlling the forward and backward rotations of the DC motor. Because the DC motor keeps driving slightly due to inertia when the brake is put on, it has been difficult to stop the punch blades at the specific HP during perforation or after perforation processing.

Under these circumstances, in order to detect an amount of driving of the motor, an encoder that rotates in association with driving by the motor and an encoder sensor are combined to count pulses obtained from the encoder. The punch blades are returned to the HP by detecting whether the punch blades have not reached or overrun the HP on the basis of the pulse count. (JP-A-2005-75550).

In a case where a sheet of paper is left and the punch blades stop by cutting into the sheet of paper, in order to return the punch blades to a normal state, the punch blades are manually returned to the HP using a knob or the like provided separately or the punch blades are returned to the HP by depressing a rest button or the like provided separately.

Normally, when a sheet of paper left inside the image forming apparatus due to paper jamming or the like is removed, it is removed by opening the image forming apparatus main body cover. A sensor that detects the opening of the cover is provided, and upon detection of the opening of the cover, the punch blades cutting into the sheet of paper being left are returned to a normal state.

However, there is more than one cause that makes the punch blades fail to return to the HP and stop on the way during a perforation operation on a sheet of paper, and there are circumstances that cannot be addressed by the technique in the related art. In addition, which returning means is most appropriate for the returning method to the HP depends on case by case, and when inappropriate returning means is adopted, there is a risk of damaging the punch unit.

### BRIEF SUMMARY OF THE INVENTION

It is an object of the present invention to provide a punch unit that performs return control in response to a stop situation of the punch blades.

In an aspect of the present invention, a punch unit that perforates a sheet of paper using a punch blade includes: a driving motor that drives the punch blade to rotate in a vertical direction; memory means for storing a rotating direction of the punch blade; home position detection means for detecting a home position of the punch blade; and control means for controlling one of a driving operation and a stopping operation of the driving motor, wherein in a case where the punch blade causes an abnormal stop when the punch blade is driven to return to the home position after suspension of perforation processing, the punch blade is returned to the home position by rotating the punch blade in a direction inverse to the rotating direction of the punch blade stored when driven to return to the home position.

### DESCRIPTION OF THE DRAWINGS

FIG. 1 is a schematic view of a punch unit according to one embodiment of the invention when viewed from the downstream side of a carrying path;

FIG. 2 is a cross section of the punch unit according to one embodiment of the invention when viewed from front side;

FIG. 3 is a perspective view showing a major portion of the punch unit according to one embodiment of the invention;

FIG. 4 is a view used to describe the positional relation of respective shielding plates;

FIG. 5 is a view used to describe the positional relation of the respective shielding plates during an operation of the punch unit according to one embodiment of the invention;

FIG. 6A and FIG. 6B are views used to describe phases after an automatic returning operation of a punch blade;

FIG. 7A, FIG. 7B, FIG. 7C, and FIG. 7D are views used to describe the phases after the automatic returning operation of the punch blade;

FIG. 8 is a flowchart showing an example of return control of the punch blade; and

FIG. 9 is a flowchart showing another example of the return control of the punch blade.

### DETAILED DESCRIPTION OF THE INVENTION

Hereinafter, embodiments of the present invention will be described with reference to the drawings. In all the drawings, like components are labeled with like reference numerals and descriptions are not repeated.

When collation, staple processing, perforation processing or the like is performed, a sheet of paper done with image formation in an image forming apparatus, such as a copying machine, is discharged from a paper discharge roller provided to the image forming apparatus and received by a sheet post-processing apparatus. The sheet post-processing apparatus basically includes a stand-by tray, a processing tray, a stapler, a paper discharge tray, and so forth.

When the user chooses the paper perforation mode, holes for filing are perforated in a sheet of paper done with image formation by the punch unit, after which the sheet of paper is discharged onto the paper discharge tray provided to the sheet post-processing apparatus. When the punch processing is not required, the carrying paths are switched, and the sheet of paper is nipped, for example, by the paper discharge roller and discharged onto the paper discharge tray.

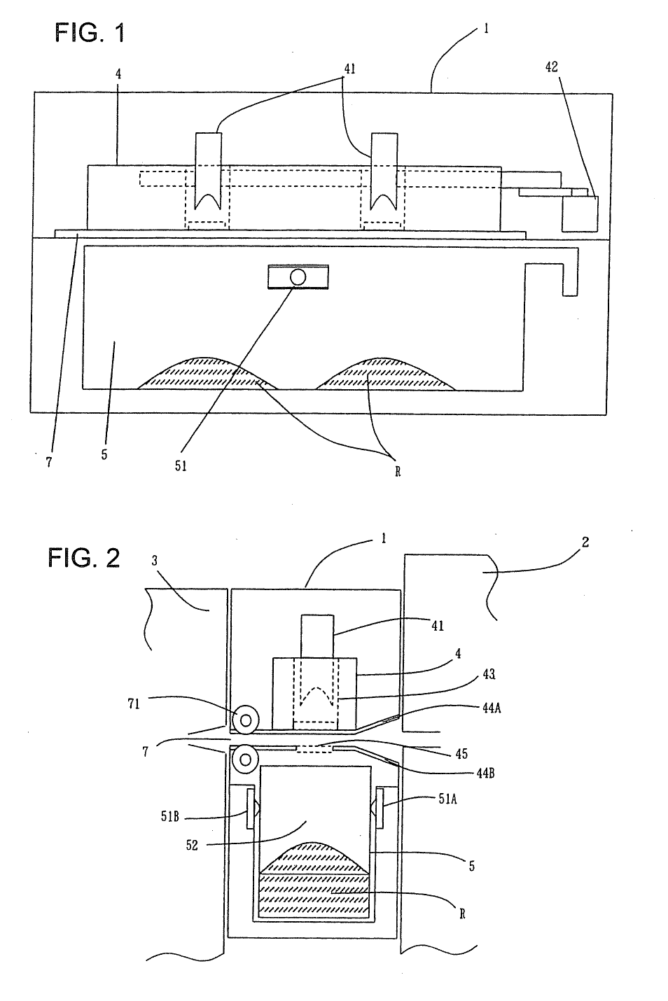

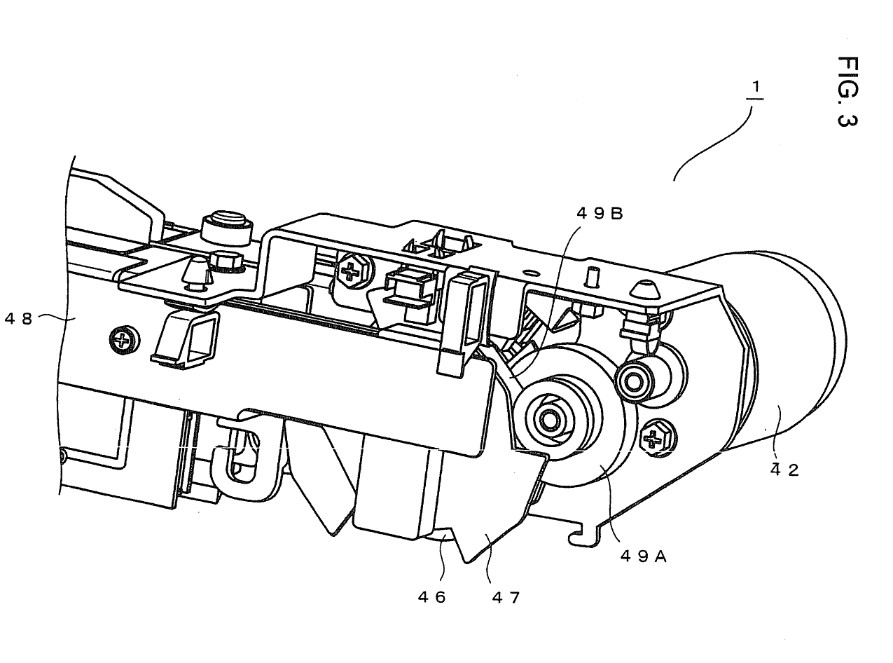

A punch unit as a whole will be briefly described with reference to FIG. 1 and FIG. 2. FIG. 1 is a schematic view of a punch unit according to one embodiment of the invention when viewed from the downstream side in the carrying path. FIG. 2 is a cross section of the punch unit according to one embodiment of the invention when viewed from the front surface side. As is shown in FIG. 2, a punch unit 1 is disposed between an image forming apparatus 2 and a sheet post-processing apparatus 3.

The sheet of paper done with image formation is discharged from the image forming apparatus 2 and received by the punch unit 1. After perforation processing is performed in the punch unit 1, the sheet of paper is carried to the sheet post-processing apparatus 3 by a carrying roller 71.

The punch unit 1 is able to punch out two or three holes. Because a choice as to whether two holes are perforated or three holes are perforated and a driving mechanism for the choice are known arts, descriptions are omitted herein.

The punch unit 1 has a punch perforation unit 4 and a punch dust box 5 for accommodating perforation dusts.

The punch perforation unit 4 is provided at a position to be orthogonal to the paper carrying direction and bridge across the carrying path. The punch perforation unit 4 can be formed of known components, and for example, it includes punch blades 41, a punch die 45, a paper guide, a return spring, and so forth. A punch motor 42 serving as a driving source is provided to the punch perforation unit 4. The punch blades 41 are driven to move up and down by the driving of the punch motor 42. The punch blades 41 normally stand by at the HP. During paper perforation, the punch blades 41 are driven to move downward along punch guides 43 fixed to a frame body 44A.

The punch die 45 is provided to a lower side frame body 44B that makes a pair with the frame body 44A having a carrying path 7 in between. The punch die 45 is allowed to engage with the punch blades 41. A sheet of paper is perforated as the punch blades 41 pass by the punch die 45 and are driven to move further downward. Punch dusts R after perforation are accumulated in a punch dust box 5.

A full punch dust detection sensor 51 is provided to the punch dust box 5. The full punch dust detection sensor 51 is formed of a light receiving portion 51A and a light emitting portion 51B.

As is shown in FIG. 3, the punch unit 1 includes the driving motor 42 for perforation processing, home position detection means 46 for detecting the HP of the punch blades 41, trigger generation means 47 for generating a control trigger to drive or stop the driving motor 42, and control means (not shown) for controlling a driving or stopping operation of the driving motor in response to outputs from the home position detection means and the trigger generation means. The control to stop the driving motor 42 by the control means is to stop the punch blades 41 at the HP by combining chopping driving, short brake, and inverse braking operation of the driving motor 42. The driving motor 42 is a driving source for a punch operation while performing forward and inverse half rotation driving, and a DC brush motor is suitable. When the DC brush motor 42 serving as the perforation driving source rotates, a gear 49A and a crank gear 49B start to rotate, which causes a slide link 48 to slide horizontally. As the slide link 48 slides, the punch blades 41 move vertically and a perforation operation is performed. A known mechanism can be used as a mechanism that transmits sliding to a vertical motion of the punch.

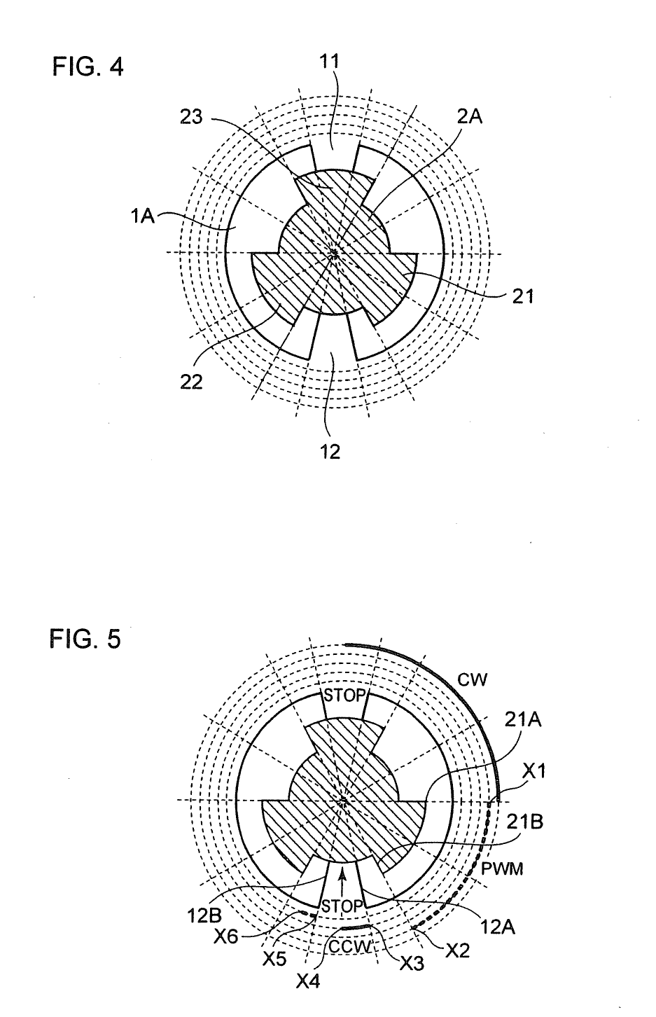

As is shown in FIG. 4, the home position detection means 46 includes a shielding plate 1A in which two notched portions 11 and 12 specifying the HP are made and a light-transmitting photo-sensor (not shown). The shielding plate 1A is provided with a shielding portion that blocks transmitted light, and rotates in association with rotations of the light-transmitting photo-sensor and the driving motor. The photo-sensor is provided to sandwich the shielding plate 1A from above and below, and it utilizes the fact that a sensor output varies with blocking and transmission of light depending on the position of the shielding plate 1A.

The trigger generation means 47 is a trigger-type sensor in which blocking units 21, 22, and 23 having a rotating angle of 60 degrees are formed at three points at intervals of 120 degrees, and includes a plate 2A formed symmetrical about a point and also symmetrical about a line. The trigger sensor 47 rotates in association with the punch motor 42, and applies the brake on the punch motor 42 by switching processing using the edges of the blocking units 21, 22, and 23 as triggers.

In this embodiment, break control in three steps as follows is performed.

### 1) Chopping Driving (PWM Driving)

This brake control is to decrease the speed of the punch blade gradually by switching the direct current electricity applied to the DC motor 30N and OFF on a regular basis. For example, the speed is controlled by the pulse width modulation (PWM) driving.

### 2) OFF Control

This brake control is to completely shut OFF the driving current to the DC motor 3.

### 3) Inverse Driving (CCW Driving)

This brake control is to rotate the DC motor 3 inversely, for example, in a semi-clockwise direction.

The brake control in these three steps is switched at timing using the edges of the trigger sensor 47 as triggers, more specifically, by using a change from blocking to transmission to blocking as a trigger.

Descriptions will be given in accordance with the explanatory view of the positional relation of the respective shielding plates shown in FIG. 5.

The punch perforation portion stands by at the HP on the start side until an operation starts. This is detected by the coming ON of the HP sensor.

Initially, the HP sensor 46 is driven in a forward rotating CW direction for a perforation operation from a state where it stops at the position of the HP 11.

Subsequently, the edge 21A of the shielding plate 21 of the trigger sensor 47 changing from transmission to blocking is detected. Upon detection of this edge, PWM driving by the chopping operation for repetitively switching ON and OFF is performed over a certain period from X1 to X3 shown in FIG. 5 to decrease the rotating speed of the DC motor.

Subsequently, the edge 21B of the shielding plate 21 changing from blocking to transmission is detected. Upon detection of this edge, the driving of the DC motor is kept turned OFF over a certain period from X2 to X3 shown in FIG. 5.

Because the DC motor keeps driving due to inertia, the edge 12A of the HP sensor 46 for the HP 12 changing from blocking to transmission is detected. Upon detection of the edge 12A, the inverse brake is put on the HP sensor 46 by being driven in an inverse rotating CCW direction to stop at the HP 12. The inverse brake is applied for X msec from X3 to X4 shown in FIG. 5.

As has been described, the punch perforation portion is stopped at the HP by the brake control in three steps.

In the event of the occurrence of paper jamming inside the image forming apparatus during paper perforation, it is necessary to remove the jammed sheet of paper. To this end, the cover of the apparatus main body is opened and the jammed sheet of paper is removed from a point where the jamming occurred. For safety, it is configured in such a manner that the paper perforation operation is suspended and the punch blades are returned to the HP automatically when the cover of the apparatus main body is opened. Because the automatic returning operation of the punch blades can be performed by a known method, descriptions are omitted herein.

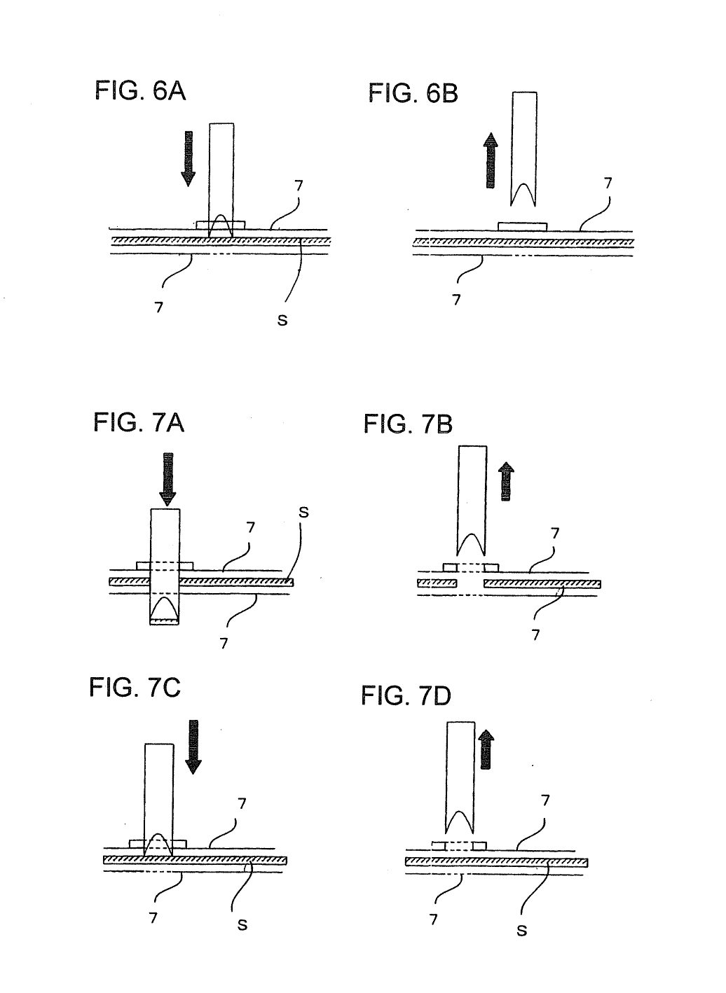

Hereinafter, an operation after the automatic returning operation of the punch blades will be described with reference to FIG. 6 through FIG. 9. FIG. 6A and FIG. 6B are views used to describe phases after the automatic returning operation of the punch blades.

An event that the punch blades stop while they protrude from the HP, that is, an abnormal stop, occurs in two manners.

Assume that the punch motor is rotated in a forward rotating (CW) direction during the perforation operation. As is shown in FIG. 6A, a first phase of the abnormal stop is a case where the punch blade makes an attempt to perforate a sheet of paper S but it fails to perforate the sheet of paper S and causes an abnormal stop. An insufficient torque of the punch motor is attributed to this abnormal stop. In this case, it is necessary to drive the punch motor in an inverse (CCW) direction for returning the punch blade to the HP as is shown in FIG. 6B.

A second phase of the abnormal stop will now be described. FIG. 7A, FIG. 7B, FIG. 7C, and FIG. 7D are views used to describe the phase after the automatic returning operation of the punch blades. It is a case where the punch blade that perforated a sheet of paper S as is shown in FIG. 7A and has returned to the HP (shown in FIG. 7B) comes back due to the inverse brake put on for stopping the punch motor (shown in FIG. 7C). This abnormal stop occurs because the punch motor speed becomes slower than a normal speed during perforation. A variance in characteristic of the punch motor, a variance in driving voltage, a difference in thickness of perforated sheets of paper, a variance in mechanical load among units, and so forth are attributed to this abnormal stop.

Because the punch blade stops while the inverse brake is driven in the CCW direction, as is shown in FIG. 7D, it is necessary to drive the punch motor in the CW direction for returning the punch blade to the HP position.

Once the punch blade stops in either of the phases of the abnormal stop as described above, by merely driving the punch motor in an inverse direction to return the punch blade to the HP, the punch blade is driven further in a direction to perforate the sheet of paper and fails to return to the HP.

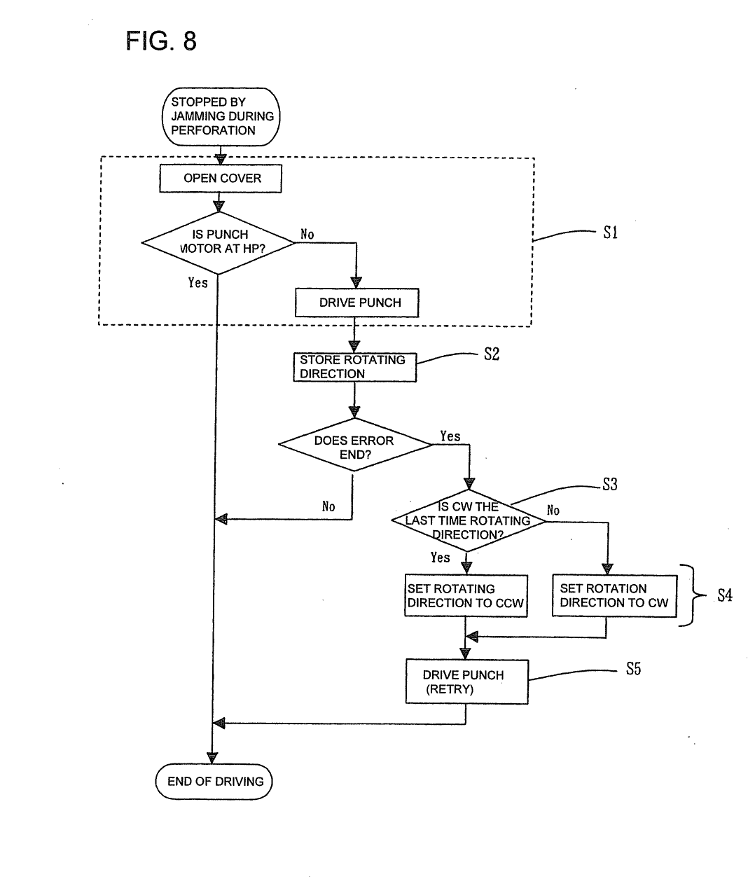

A first embodiment of the invention will be described in accordance with the flowchart of FIG. 8 showing an example of the return control of the punch blade.

This is a case where paper jamming occurred in the image forming apparatus during perforation and the perforation operation is stopped. Initially, the apparatus main body cover is opened to remove the jamming. In this instance, whether the punch blades have stopped at the HP is checked. In a case where the punch blades have stopped at the HP, there is no need to drive the punch motor. In a case where the punch blades are not at the HP, the punch motor is driven to perform the automatic returning operation of the punch blades to the HP (Step S1).

When this driving is performed, the rotating direction of the punch motor for the return driving is stored (Step S2).

In a case where the stop phase of the punch blades is the one shown in FIG. 6A and the driving for the returning operation is performed in the CCW direction, the returning operation ends normally as is shown in FIG. 6B, whereupon the operation ends.

In a case where the stop phase of the punch blades is the one shown in FIG. 7A through FIG. 7C and the driving for the returning operation is performed in the CCW direction, the returning driving causes an abnormal stop. When the abnormal stop is determined, the rotating direction stored in Step S2 is checked. For example, whether the stored rotating direction is the CW direction is checked (Step S3).

A rotating direction inverse to the stored rotating direction is set by setting the CCW direction when the stored rotating direction is the CW direction and by setting the CW direction when the stored rotating direction is the CCW direction (Step S4). Subsequently, the punch motor is driven for a retry in the rotating direction thus set (Step S5).

As are shown in FIG. 7A through FIG. 7C, because the punch motor has been driven in the CCW direction, it is driven in the CW direction by the retry driving. Accordingly, as is shown in FIG. 7D, it is possible to return the punch blades to the HP in a normal manner.

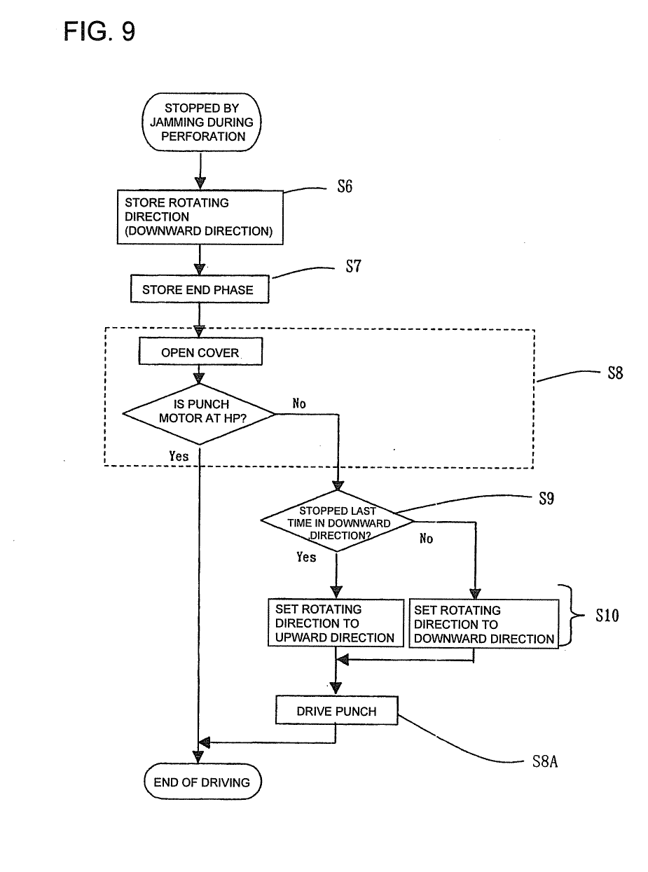

A second embodiment of the present invention will be described in accordance with the flowchart showing another example of the return control of the punch blades shown in FIG. 9. This is a case where paper jamming occurred in the image forming apparatus during perforation and the perforation operation is stopped.

In the second embodiment, the rotating direction of the punch motor is stored each time the driving of the punch motor is stopped (Step S6), and further, the operation stop phase of the punch blades is stored (Step S7).

The rotating direction stored in the Step S6 is the rotating direction in a downward direction at the beginning of the driving. The driving stop phase stored in Step S7 is stored as a stop in the downward direction phase when the punch motor stopped as is shown in FIG. 6A, and as the phase after the driving in the upward direction when stopped as is shown in FIG. 7A.

Subsequently, the apparatus main body cover is opened for removing the jamming. In this instance, whether the punch blades have stopped at the HP is checked. In a case where the punch blades have stopped at the HP, there is no need to drive the punch motor. In a case where the punch blades are not at the HP, the punch motor is driven to perform the automatic returning operation of the punch blades to the HP (Step S8).

With respect to the driving direction in this instance, whether the last driving stop occurred during the downward driving or after the upward driving is determined from the stop phase stored in Step S7. For example, whether the punch motor stopped during the downward driving is checked (Step S9). The rotating direction is set for the punch motor to be driven in a direction inverse to the stored direction by setting the rotating direction to an upward direction when the punch motor stopped during the downward driving and by setting the rotating direction to a downward direction when stopped during the upward driving (Step S10). Subsequently, the punch motor is driven in the rotating direction thus set to perform the automatic returning operation of the punch blades (Step S8A).

In the second embodiment, because the upward direction is set as the direction set in Step S10 when the downward direction is determined in Step S9, an inverse direction to the driving direction stored in Step S6 is set, whereas because the downward direction is set when the upward direction is determined, the same direction as the driving direction stored in Step S6 is set. Accordingly, it is possible to return the punch blades to the HP normally as are shown in FIG. 6B and FIG. 7D.

As has been described, the cause of a stop of the punch blades can be understood and the most appropriate returning means is applied, the punch blades are allowed to return to the HP in a reliable manner without causing damages or the like. In addition, by implementing the present invention, the number of sensors or the like can be reduced, which can in turn save the cost.

Although exemplary embodiments of the present invention have been shown and described, it will be apparent to those having ordinary skill in the art that a number of changes, modifications, or alternations to the invention as described herein may be made, none of which depart from the spirit of the present invention. All such changes, modifications, and alternations should therefore be seen as within the scope of the present invention.

What is claimed is:

1. A punch unit that perforates a sheet of paper using a punch blade, comprising:
a driving motor that drives the punch blade to rotate in a vertical direction;
memory means for storing a rotating direction of the punch blade;
home position detection means for detecting a home position of the punch blade; and
control means for controlling one of a driving operation and a stopping operation of the driving motor,
wherein in a case where the punch blade causes an abnormal stop when the punch blade is driven to return to the home position after suspension of perforation processing, the punch blade is returned to the home position by rotating the punch blade in a direction inverse to the rotating direction of the punch blade stored when driven to return to the home position.

2. The punch unit according to claim 1, wherein:
the suspension of the perforation processing associates with an opening of a main body cover of an image forming apparatus.

3. The punch unit according to claim 1, wherein:
a phase of the abnormal stop of the punch blade is a state where the punch blade has cut into the sheet of paper and becomes unable to perforate the sheet of paper.

4. The punch unit according to claim 1, wherein:
a phase of the abnormal stop of the punch blade is a state where the punch blade failed to return to the home position after the punch blade perforated the sheet of paper and has come back toward the sheet of paper.

5. A punch unit that perforates a sheet of paper using a punch blade, comprising:
a driving motor that drives the punch blade to rotate in a vertical direction;
memory means for storing a rotating direction and a phase at an end of perforation of the punch blade for each perforation;
home position detection means for detecting a home position of the punch blade; and
control means for controlling one of a driving operation and a stopping operation of the driving motor,
wherein in a case where the punch blade causes an abnormal stop when the punch blade is driven to return to the home position after suspension of perforation processing, the punch blade is returned to the home position by rotating the punch blade in a direction inverse to the rotating direction of the punch blade stored at the end of the perforation.

6. The punch unit according to claim 5, wherein:
the suspension of the perforation processing associates with an opening of a main body cover of an image forming apparatus.

7. The punch unit according to claim 5, wherein:
a phase of the abnormal stop of the punch blade is a state where the punch blade has cut into the sheet of paper and becomes unable to perforate the sheet of paper.

8. The punch unit according to claim 5, wherein:
a phase of the abnormal stop of the punch blade is a state where the punch blade failed to return to the home position after the punch blade perforated the sheet of paper and has come back toward the sheet of paper.

9. A sheet post-processing apparatus, comprising:
the punch unit according to any one of claims 1 through 8; and
sheet post-processing means for discharging a sheet of paper after performing processing including the perforation processing on the sheet of paper.
